(19) United States
(12) Patent Application Publication
(10) Pub. No.: US 2015/0339972 A1
(43) Pub. Date: Nov. 26, 2015

(54) AMOLED DISPLAY DEVICE AND PIXEL DRIVING METHOD THEREOF

(71) Applicant: SHENZHEN CHINA STAR OPTOELECTRONICS TECHNOLOGY CO. LTD., Shenzhen, Guangdong (CN)

(72) Inventor: Xiangyang XU, Shenzhen (CN)

(21) Appl. No.: 14/380,920

(22) PCT Filed: May 30, 2014
(86) PCT No.: PCT/CN2014/078905

§ 371 Date: Aug. 25, 2014

(30) Foreign Application Priority Data
Feb. 20, 2014 (CN) 201410058374.9

(51) Int. Cl. G09G 3/32

(52) U.S. Cl. CPC G09G 3/32

(57) ABSTRACT

The present invention relates to an AMOLED display device and a pixel driving method thereof. The device comprises a sub-pixel unit array formed on the substrate, wherein each of the sub-pixel unit includes two secondary sub-pixel units arranged side by side and having the same color. For switching transistors in the secondary sub-pixel units of the same column, first ends of which transistors are connected in parallel to the same data line to receive a data signal. One end of each data line is connected through a first control switch unit to a data driving unit, and when the first control switch unit on a data line of odd column is turned on/off, the first control switch unit on a data line of even column is turned off/on, so that the two secondary sub-pixel units arranged side by side and having the same color emit light in an alternate manner in term of different frames of pictures.

The present application claims priority of Chinese patent application No. 201410058374.9, filed on Feb. 20, 2014 and titled as “AMOLED display device and pixel driving method thereof”, the entire contents of which are incorporated herein by reference thereto.

### FIELD OF THE INVENTION

The present disclosure relates to an organic light emitting panel display technology, in particular to an AMOLED display device and a pixel driving method thereof.

### BACKGROUND OF THE INVENTION

An organic light emitting diode (OLED) has the advantages of self-illumination, ultra lightness and thinness, wide view angle, low power consumption, bendability and the like, and thus a display panel based on the OLEDs becomes a research focus of display technology. In this case, an active matrix organic light emitting diode (AMOLED) with excellent performance and good development prospect becomes a main trend of development in the future.

Compared with a thin film transistor-liquid crystal display (TFT-LCD), the AMOLED needs to use driving transistors in addition to switching transistors, and thereby drives the organic light emitting diodes to emit light by current generated by the driving transistors in a saturated state. Generally, in a row-by-row scanning manner, a switching transistor on each row which is connected with a row of scan line is turned on by means of a signal on the row of scan line, so that a voltage signal on a data line is transmitted to a driving transistor connected with the switching transistor, by which driving transistor the voltage signals is converted into current for driving the organic light emitting diode to work. This operation manner requires the driving transistors to output constant current. In other words, under the condition of the same gate voltage, the driving currents output by respective driving transistors on the same row needs to be kept simultaneous in term of time and uniform in term of space. However, due to the influence of fabrication, the threshold voltages of the transistors would drift. On the other hand, because of the transfer characteristic of a transistor, i.e., the transfer characteristic curve of the transistor during the gate voltage is changed from a positive voltage to a negative voltage (forward scanning) is different from that from a negative voltage to a positive voltage (backward scanning), the threshold voltage of the transfer characteristic curve during the backward scanning is lower than that during the forward scanning. Therefore, in practical application, even if the same gray-scale voltage is input to the data lines, the driving current flowing through the organic diodes of respective pixel units are still different, so that the brightness of an AMOLED display is not uniform, and then the picture imaging effect is affected.

Moreover, the OLED further has an aging problem. In the prior art, the OLED is generally driven by means of the direct current, and the transmission direction of holes and electrons is unchanged. That is, the holes and the electrons are injected into a light emitting layer from the anode and the cathode, respectively, to form excitons in the light emitting layer so as to realize radiation luminescence. Redundant holes (or electrons) which fail to be combined are accumulated on the interface of a hole transmission layer/light emitting layer (or of a light emitting layer/electron transmission layer), or come over a potential barrier and then flow into an electrode. With the extending of working time, many uncombined holes or electrons are accumulated on the internal interface of the light emitting layer of the OLED to form an internal electric field, so that the threshold voltage is continuously raised and the brightness of the OLED is continuously reduced, and thereby the energy utilization efficiency is gradually reduced. For this reason, how to effectively overcome or eliminate the defects of non-uniform brightness, low energy utilization rate and relatively short service life become a problem to be urgently solved for related technicians in the industry.

### SUMMARY OF THE INVENTION

Aiming at the above-mentioned technical problems, the present disclosure provides a new AMOLED display device and a driving method thereof. In the present AMOLED display device, a traditional sub-pixel is divided into two portions, i.e., two secondary sub-pixels which are driven to emit light in an alternate manner in term of different frames of pictures, so that the light emitting duration of the OLED is shortened and the service life of the OLED is thereby prolonged.

An AMOLED display device provided by the present disclosure comprises a substrate and a sub-pixel unit array formed on the substrate, wherein:

each of the sub-pixel unit includes two secondary sub-pixel units arranged side by side and having the same color, and each secondary sub-pixel unit is correspondingly connected to a scan line and a data line;

for switching transistors in the secondary sub-pixel units of the same column, first ends of which switching transistors are connected in parallel to the same data line to receive a data signal output by a data driving unit, and control ends of which are correspondingly connected with their respective scan lines arranged along the scanning direction to receive a scan signal output by a scan driving unit sequentially, and wherein under the action of the scan signal, the data signal is transmitted to a driving transistor in the related secondary sub-pixel unit, so as to drive an organic light emitting diode in the related secondary sub-pixel unit to emit light;

one end of each data line is connected to an output end of the data driving unit through a first control switch unit, and wherein when the first control switch unit on a data line of odd column is turned on/off, the first control switch unit on a data line of even column is turned off/on, so that two secondary sub-pixel units arranged side by side and having the same color emit light in an alternate manner in term of different frames of pictures.

According to an embodiment of the present disclosure, a control end of the first control switch unit on the data line of odd column is connected with a first control signal line to receive a first control signal, under the action of which signal the first control switch unit on the data line of odd column is turned on or off; and

a control end of the first control switch unit on the data line of even column is connected with a second control signal line to receive a second control signal, under the action of which signal the first control switch unit on the data line of even column is turned on or off.

Further, the other end of each data line is also connected to a second voltage VSS through a second control switch unit, and wherein when the first control switch unit on the data line of odd column and the second control switch unit on the data line of even column are both turned on/off, the first control switch unit on the data line of even column and the second control switch unit on the data line of odd column are both turned off/on.

According to an embodiment of the present disclosure, a control end of the second control switch unit on the data line of odd column may be connected with the second control signal line to receive the second control signal, under the action of which signal the second control switch unit on the data line of odd column is turned on or off; and

a control end of the second control switch unit on the data line of even column is connected with the first control signal line to receive the first control signal, under the action of which signal the second control switch unit on the data line of even column is turned on or off.

Moreover, said first control signal and said second control signal are opposite phase but synchronous periodic pulse signals relative to each other, and the period of the periodic pulse signals is a picture refresh frame period.

According to an embodiment of the present disclosure, the data lines of the two secondary sub-pixel units arranged side by side and having the same color may be connected to the same data wire of the data driving unit to receive the same data signal.

According to an embodiment of the present disclosure, the above-mentioned first control switch unit includes a switching transistor, a first end of which switching transistor is connected with the corresponding data line, a second end of which is connected with the output end of the data driving unit, and a control end of which receives the first control signal or the second control signal.

According to an embodiment of the present disclosure, the above-mentioned second control switch unit includes a switching transistor, a first end of which switching transistor is connected with the corresponding data line, a second end of which is connected with the second voltage VSS, and a control end of which receives the first control signal or the second control signal.

In addition, the present disclosure further provides a pixel driving method for the AMOLED display device, wherein:

said AMOLED display device includes a substrate and a sub-pixel unit array formed on the substrate, wherein each of the sub-pixel units includes two secondary sub-pixel units arranged side by side and having the same color, and each secondary sub-pixel unit is correspondingly connected with a scan line and a data line; for switching transistors in the secondary sub-pixel units of the same column, first ends of which switching transistors are connected in parallel to the same data line to receive a data signal output by a data driving unit, and the control ends of which are correspondingly connected with their respective scan lines arranged along the scanning direction to receive a scan signal output by a scan driving unit; one end of each data line is connected to an output end of the data driving unit through a first control switch unit;

the pixel driving method comprises:

outputting, by a scan driving unit, a scan signal;

outputting, by a data driving unit, a data signal;

controlling a first control switch unit on a data line of odd column to be turned on/off simultaneously with controlling the first control switch unit on a data line of even column to be turned off/on, so that the two secondary sub-pixel units arranged side by side and having the same color receive the data signal in term of different frames of pictures and, under the action of the scan signal, the data signal is transmitted to the related internal driving transistor, so as to drive an internal organic light emitting diode to emit light.

According to an embodiment of the present disclosure, the above-mentioned pixel driving method may include:

applying a first control signal to a control end of the first control switch unit on the data line of odd column;

applying a second control signal to a control end of the first control switch unit on the data line of even column;

wherein said first control signal and said second control signal are opposite phase but synchronous periodic pulse signals relative to each other, and the period of the periodic pulse signals is a picture refresh frame period.

Further, on the substrate of the above-mentioned AMOLED display device, the other end of each data line is also connected to a second voltage VSS through a second control switch unit; based on this, said pixel driving method further includes:

controlling the first control switch unit on the data line of odd column and the second control switch unit on the data line of even column to be turned on/off simultaneously with controlling the first control switch unit on the data line of even column and the second control switch unit on the data line of odd column to be turned off/on.

According to an embodiment of the present disclosure, the above-mentioned pixel driving method may include:

applying a first control signal to control ends of the first control switch unit on the data line of odd column and to control ends of the second control switch unit on the data line of even column,

applying a second control signal to control ends of the second control switch unit on the data line of odd column and to control ends of the first control switch unit on the data line of even column;

wherein the first control signal and the second control signal are opposite phase but synchronous periodic pulse signals relative to each other, and the period of the periodic pulse signals is a picture refresh frame period.

Compared with the prior art, the present disclosure brings the following beneficial effects:

1. The sub-pixel unit in the prior art is divided into two portions in the present disclosure, namely, each sub-pixel unit includes two secondary sub-pixel units arranged side by side and having the same color, which emit light in an alternated manner in term of different frames of pictures by means of the first control switch unit, so that the light emitting duration of the OLED is shortened, and thus the service life of the display panel is prolonged to a certain extent.

2. Further, each data line is connected to the second voltage VSS through the second control switch unit in the present disclosure, so that when the second control switch unit is turned on, uncombined current carriers which are accumulated on an internal interface of a light emitting layer of the organic diode in the secondary sub-pixel unit may be released to the low-potential second voltage VSS through the second control switch unit, so that the built-in electric field of the organic light emitting diode may be reduced, avoiding the threshold voltage drift to a certain extent, and then improving non-uniform brightness and low energy utilization efficiency caused by the threshold voltage drift in the prior art.

Other features and advantages of the present disclosure will be illustrated in the following description, and become partially apparent from the description or may be understood through implementing the present disclosure. The objectives and other advantages of the present disclosure may be achieved and obtained by structures specified in the description, the claims and the accompanying drawings.

### BRIEF DESCRIPTION OF THE DRAWINGS

The accompanying drawings are configured to provide a further understanding of the present disclosure, and constitute a part of the description to explain the present disclosure together with the embodiments of the present disclosure, rather than limiting to the present disclosure. In the accompanying drawings:

FIG. 1 is a schematic diagram of a pixel unit array on a substrate of an AMOLED display panel in the prior art;

FIG. 2 is an equivalent circuit diagram of a “2T1C” pixel unit of the AMOLED display panel in the prior art;

FIG. 3 is a schematic diagram of a pixel unit array on a substrate of an AMOLED display panel according to an embodiment of the present disclosure; and

FIG. 4 is a time sequence diagram of driving control signals of a pixel unit of the AMOLED display panel according to an embodiment of the present disclosure.

### DETAILED DESCRIPTION OF THE EMBODIMENTS

In order to make the technical contents disclosed by the present disclosure more detailed and complete, the objectives, technical solutions and technical effects of the present disclosure will be described below in detail with reference to the accompanying drawing and specific embodiments. It should be particularly noted that, although an AMOLED display panel with a “2T1C” pixel unit architecture is illustrated below, those skilled in the art should understand that such embodiment is not intent to limit the scope of the present disclosure, and the structures of pixel units designed by various manufacturers are different. Moreover, the accompanying drawings are merely used for schematic illustration, and are not drawn in term of its original scale.

FIG. 1 is a schematic diagram of a pixel unit array on a substrate of an AMOLED display panel in the prior art. The pixel unit array on the substrate consists of pixel units defined by intersecting a plurality of scan lines Gn−1, Gn, Gn+1 . . . with a plurality of data lines Dn−1, Dn, Dn+1 . . . . The pixel units herein typically are sub-pixel units of three primary colors adopted for color display (denoted as R. G and B in the figure). Each sub-pixel unit is correspondingly connected with one scan line and one data line, and adopts a architecture of “2T1C” circuit form. In this case, “2T” refers to thin-film transistors T1 and T2, and “1C” refers to a storage capacitor Cs.

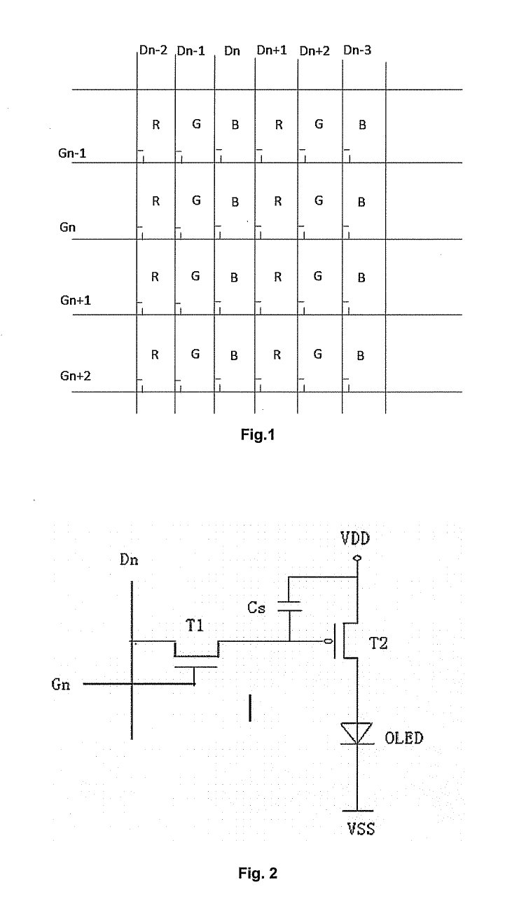

FIG. 2 shows a circuit structure of such pixel unit.

The thin-film transistor T1 is a switching transistor, the gate of which is electrically connected with a corresponding scan line Gn, the source of which is electrically connected with a corresponding data line Dn, and the drain of which is electrically connected to the gate of the thin-film transistor T2 serving as a driving transistor. The gate of the thin-film transistor T2 is electrically connected to a first voltage VDD, and the drain thereof is electrically connected to the anode of an organic light emitting diode (OLED). The cathode of the OLED is electrically connected to a second voltage VSS. An upper and lower electrodes of the storage capacitor Cs are electrically connected to the first voltage VDD and the gate of the thin-film transistor T2 respectively.

A scan driving unit (not shown in the figure) of the AMOLED display panel sequentially inputs, along the scanning direction, a scan signal to the scan lines. When the scan line Gn is scanned, the scan signal on the scan line Gn is of high level and then the source and drain of the thin-film transistor T1 are turned on, so that a data signal on the data line Dn is transmitted to the gate of the thin-film transistor T2. As a result, a corresponding driving current is generated between the source and drain of the thin-film transistor T2 due to the data signal on the gate of the thin-film transistor T2. The driving current flows through the OELD to cause the OELD to emit light. Under the action of the storage capacitor Cs, even if the scan signal on the scan line Gn disappears, the data signal on the gate of the thin-film transistor T2 can remain until the gate of the thin-film transistor T1 receives a new scan signal output by the scan driving unit at the next period.

To solve the problems that the AMOLED display device is prone to aging and non-uniform in brightness, the present disclosure proposes to divide one sub-pixel unit in the prior art into two portions. In other words, each sub-pixel unit includes two secondary sub-pixel units arranged side by side and having the same color, and the two secondary sub-pixel units emit light in an alternate manner in term of different frames of pictures, so that the light emitting duration of the OLED is shortened, and thus the service life of the display panel is prolonged to a certain extent.

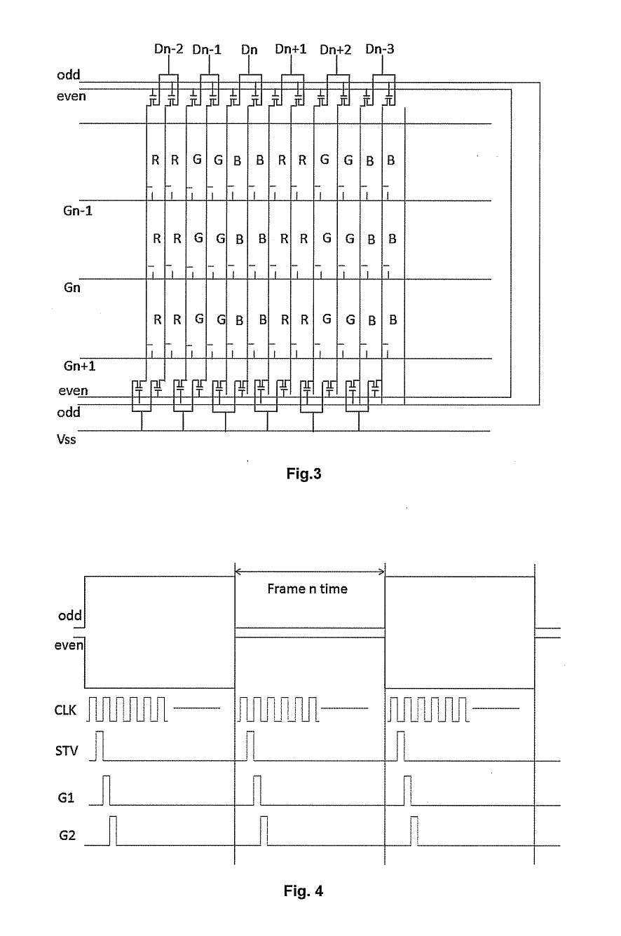

FIG. 3 is a schematic diagram of a pixel unit array on a substrate of an AMOLED display panel according to an embodiment of the present disclosure. It can be seen from the figure, similar to the substrate of the existing AMOLED display panel, each of the secondary sub-pixel units on the substrate of the present disclosure has the same structure and is correspondingly connected with one scan line and one data line. Different from the substrate of the existing AMOLED display panel, to realize a technical effect that two secondary sub-pixel units of one sub-pixel unit emit light in an alternate manner in term of different frames of pictures, a corresponding control circuit is further needed.

The specific circuit structure may be configured as follows.

On the substrate, in the secondary sub-pixel units of the same column, the sources of respective switching transistors are connected in parallel to the same data line to receive a data signal output by a data driving unit. The gates of the switching transistors are correspondingly connected to respective scan lines arranged along the scanning direction to receive a scan signal output by said scan driving unit. Under the action of the scan signal, the data signal is transmitted to the driving transistor located in the related secondary sub-pixel unit, so as to drive the organic light emitting diode in this related secondary sub-pixel unit to emit light. Meanwhile, one end of each data line is connected to an output end of the data driving unit via a first control switch unit Switch 1, and the other end of the data line is connected to the second voltage VSS via a second control switch unit Switch 2, wherein:
control ends of both the first control switch unit Switch 1 of a data line of odd column and the second control switch unit Switch 2 of a data line of even column are connected with a first control signal line “even” to receive a first control signal EVEN; and
control ends of both the second control switch unit Switch 2 of the data line of odd column and the first control switch unit Switch 1 of the data line of even column are connected with a second control signal line “odd” to receive a second control signal ODD.

When the first control signal EVEN and the second control signal ODD are opposite phase but synchronous periodic pulse signals relative to each other, the following technical effects may be realized:
when the first control switch unit Switch 1 of the data line of odd column and the second control switch unit Switch 2 of the data line of even column are turned on under the action of the first control signal EVEN, the second control switch unit Switch 2 of the data line of odd column and the first control switch unit Switch 1 of the data line of even column are then turned off;
when the second control switch unit Switch 2 of the data line of odd column and the first control switch unit Switch 1 of the data line of even column are turned on under the action of the second control signal ODD, the first control switch unit Switch 1 of the data line of odd column and the second control switch unit Switch 2 of the data line of even column are then turned off.

The first control signal EVEN and the second control signal ODD are opposite phase but synchronous periodic pulse signals relative to each other. Preferably, the period of the periodic pulse signals is a picture refresh frame period. Thus, the two secondary sub-pixel units arranged side by side and having the same color (which are two secondary sub-pixel units belonging to the same sub-pixel unit) receive, in an alternative manner, the data driving signals output by the data driving unit through their respective connected data lines under the action of the first and the second control signals, so as to alternatively emit light in term of different frames of pictures and then prolong the service life of the display panel to a certain extent.

Further, due to the second control switch unit, when the second control switch unit is turned on, uncombined current carriers which are accumulated on an internal interface of a light emitting layer of the organic diode in the secondary sub-pixel unit may be released to the low-potential second voltage VSS through the second control switch unit, so that the built-in electric field of the organic light emitting diode may be reduced, avoiding the drift of threshold voltage to a certain extent, and thereby improving non-uniform brightness and low energy utilization efficiency caused by the threshold voltage drift in the prior art.

In the above-mentioned embodiment, the first control switch unit may include a switching transistor (preferably, a thin-film transistor), a first end of which is connected to the corresponding data line, and a second end of which is connected to the output end of the data driving unit, and a control end of which receives the first control signal or the second control signal. The second control switch unit may include a switching transistor (preferably, a thin-film transistor), wherein a first end thereof is connected to the corresponding data line, a second end thereof is connected to the second voltage VSS, and a control end thereof receives the first control signal or the second control signal.

In the above-mentioned embodiment, the data lines of the two secondary sub-pixel units arranged side by side and having the same color may be connected, respectively, to the same data wire (denoted as Dn−2, Dn−1, Dn, Dn+1, Dn+2 . . . in FIG. 3) at the output end of the data driving unit through their respective first control switch units. In this way, the number of chips of the data driving unit dispenses with increase.

On the other hand, the present disclosure also provides a driving method for above-mentioned pixel unit of the AMOLED display panel. Namely, it is provided is a driving method enabling two secondary sub-pixel units arranged side by side and having the same color to emit light in an alternate manner in term of different frames of pictures. In particular, FIG. 4 shows a time sequence diagram of driving control signals for drying above-mentioned pixel unit of the AMOLED display panel (although only three periods are shown, it is not limited to so). In this case, CLK is a clock pulse signal required for driving the display panel; STV is an enabling signal for controlling the scan driving unit to output a scan signal; G1, G2 . . . Gn are scan signals on the corresponding scan lines; and the first control signal EVEN and the second control signal ODD are opposite phase but synchronous periodic pulse signals, and the period T is a picture refresh frame period.

During a display phase of a certain frame of picture, the first control signal EVEN is kept at high level and the second control signal ODD is at low, so that the first control switch units Switch 1 of the data lines of odd column and the second control switch units Switch 2 of the data lines of even column are turned on under the action of the first control signal EVEN, and at the same time, the second control switch units Switch 2 of the data lines of odd column and the first control switch units Switch 1 of the data lines of even column are turned off. In this way, under the action of the scan signal, only the secondary sub-pixel units of the odd columns emit light, the specific operation manner of which is the same as that in the prior art and will not be further described herein.

During the display phase of the next frame of picture, the first control signal EVEN is kept at low level and the second control signal ODD is at high, so that the first control switch units Switch 1 of the data lines of odd column and the second control switch units Switch 2 of the data lines of even column are turned off under the action of the first control signal EVEN, and at the same time, the second control switch units Switch 2 of the data lines of odd column and the first control switch units Switch 1 of the data lines of even column are turned on. In this way, under the action of the scan signal, only the secondary sub-pixel units of the even columns emit light, the specific operation manner of which is the same as that in the prior art and will not be further described herein.

Although the implementations disclosed by the present disclosure are described above, the contents described herein are merely embodiments for better understanding of the present disclosure, rather than limiting the present disclosure. Any modifications or variations made on the implementation form and detail by those skilled in the art without departing from the disclosed spirit and scope of the present disclosure shall fall within the patent protection scope of the present disclosure. Accordingly, the patent protection scope of the present disclosure is still subjected to the scope defined by the following claims.

1. An AMOLED display device, comprising a substrate and a sub-pixel unit array formed on the substrate, wherein:
each of the sub-pixel unit includes two secondary sub-pixel units arranged side by side and having the same color, and each secondary sub-pixel unit is correspondingly connected to a scan line and a data line;
for switching transistors in the secondary sub-pixel units of the same column, first ends of which switching transistors are connected in parallel to the same data line to receive a data signal output by a data driving unit, and control ends of which are correspondingly connected with their respective scan lines arranged along the scanning direction to receive a scan signal output by a scan driving unit sequentially, and wherein under the action of the scan signal, the data signal is transmitted to a driving transistor in the related secondary sub-pixel unit, so as to drive an organic light emitting diode in the related secondary sub-pixel unit to emit light; and
one end of each data line is connected to an output end of the data driving unit through a first control switch unit, and wherein when the first control switch unit on a data line of odd column is turned on/off, the first control switch unit on a data line of even column is turned off/on, so that two secondary sub-pixel units arranged side by side and having the same color emit light in an alternate manner in term of different frames of pictures.

2. An AMOLED display device of claim 1, wherein:
a control end of the first control switch unit on the data line of odd column is connected with a first control signal line to receive a first control signal, under the action of which signal the first control switch unit on the data line of odd column is turned on or off; and
a control end of the first control switch unit on the data line of even column is connected with a second control signal line to receive a second control signal, under the action of which signal the first control switch unit on the data line of even column is turned on or off.

3. An AMOLED display device of claim 2, wherein the first control signal and the second control signal are opposite phase but synchronous periodic pulse signals relative to each other, and the period of the periodic pulse signals is a picture refresh frame period.

4. An AMOLED display device of claim 1, wherein the first control switch unit includes a switching transistor, a control end of which transistor receives a first control signal or a second control signal, a first end of which is connected with the corresponding data line, and a second end of which is connected with the output end of the data driving unit.

5. An AMOLED display device of claim 2, wherein the first control switch unit includes a switching transistor, a control end of which transistor receives the first control signal or the second control signal, a first end of which is connected with the corresponding data line, and a second end of which is connected with the output end of the data driving unit.

6. An AMOLED display device of claim 1, wherein the other end of each data line is also connected to a second voltage VSS through a second control switch unit, and
when the first control switch unit on the data line of odd column and the second control switch unit on the data line of even column are both turned on/off, the first control switch unit on the data line of even column and the second control switch unit on the data line of odd column are both turned off/on.

7. An AMOLED display device of claim 6, wherein:
a control end of the second control switch unit on the data line of odd column is connected with the second control signal line to receive the second control signal, under the action of which signal the second control switch unit on the data line of odd column is turned on or off; and
a control end of the second control switch unit on the data line of even column is connected with the first control signal line to receive the first control signal, under the action of which signal the second control switch unit on the data line of even column is turned on or off.

8. An AMOLED display device of claim 7, wherein the first control signal and the second control signal are opposite phase but synchronous periodic pulse signals relative to each other, and the period of the periodic pulse signals is a picture refresh frame period.

9. An AMOLED display device of claim 6, wherein the second control switch unit includes a switching transistor, a control end of which receives a first control signal or a second control signal, a first end of which transistor is connected with the corresponding data line, and a second end of which is connected to the second voltage VSS.

10. An AMOLED display device of claim 7, wherein the second control switch unit includes a switching transistor, a control end of which receives a first control signal or a second control signal, a first end of which transistor is connected with the corresponding data line, and a second end of which is connected to the second voltage VSS.

11. An AMOLED display device of claim 1, wherein the data lines of two secondary sub-pixel units arranged side by side and having the same color are connected to the same data wire of the data driving unit to receive the same data signal.

12. A pixel driving method for an AMOLED display device,
the AMOLED display device comprising a substrate and a sub-pixel unit array formed on the substrate, wherein each of the sub-pixel units includes two secondary sub-pixel units arranged side by side and having the same color, and each secondary sub-pixel unit is correspondingly connected with a scan line and a data line; for switching transistors in the secondary sub-pixel units of the same column, first ends of which switching transistors are connected in parallel to the same data line to receive a data signal output by a data driving unit, and the control ends of which switching transistors are correspondingly connected with their respective scan lines arranged along the scanning direction to receive a scan signal output by a scan driving unit; and one end of each data line is connected to an output end of the data driving unit through a first control switch unit;
said pixel driving method comprising:
outputting, by a scan driving unit, a scan signal;
outputting, by a data driving unit, a data signal; and
controlling a first control switch unit on a data line of odd column to be turned on/off simultaneously with controlling the first control switch unit on a data line of even column to be turned off/on, so that two secondary sub-pixel units arranged side by side and having the same color receive the data signal in term of different frames of pictures and, under the action of the scan signal, the data signal is transmitted to the related internal driving transistor, so as to drive an related internal organic light emitting diode to emit light.

13. A pixel driving method of claim 12, wherein:
applying a first control signal to a control end of the first control switch unit on the data line of odd column,
applying a second control signal to a control end of the first control switch unit on the data line of even column,
wherein the first control signal and the second control signal are opposite phase but synchronous periodic pulse signals relative to each other, and the period of the periodic pulse signals is a picture refresh frame period.

14. A pixel driving method of claim 12, wherein on the substrate of the AMOLED display device, the other end of each data line is also connected to a second voltage VSS through a second control switch unit,
said pixel driving method further including:
controlling the first control switch unit on the data line of odd column and the second control switch unit on the data line of even column to be turned on/off simultaneously with controlling the first control switch unit on the data line of even column and the second control switch unit on the data line of odd column to be turned off/on.

15. A pixel driving method of claim 14, wherein:
applying a first control signal to control ends of the first control switch unit on the data line of odd column and to control ends of the second control switch unit on the data line of even column,
applying a second control signal to control ends of the second control switch unit on the data line of odd column and to control ends of the first control switch unit on the data line of even column,
wherein the first control signal and the second control signal are opposite phase but synchronous periodic pulse signals relative to each other, and the period of the periodic pulse signals is a picture refresh frame period.
